(19) United States
(12) Patent Application Publication
(10) Pub. No.: US 2012/0199778 A1
(43) Pub. Date: Aug. 9, 2012

(54) ON-OFF VALVE

(76) Inventor: YEN HUI HUANG, Taichung (TW)

(21) Appl. No.: 13/021,810

(22) Filed: Feb. 7, 2011

(51) Int. Cl. F16K 1/00

(52) U.S. Cl. 251/321

(57) ABSTRACT

An on-off valve contains a body including an air-inflow segment and an air-outflow segment disposed on two sides thereof respectively; a valve structure including an inlet with a small diameter fixed on and communicating with the air-inflow segment and a hole with a large diameter formed on and not communicating with the air-inflow segment, wherein the hole includes inner threads proximate to an opening of the hole, the valve structure also includes a nut having outer threads, the outer threads of the nut screw with the inner threads of the body to position the valve structure, thus connecting the on-off valve together.

### BACKGROUND OF THE INVENTION

1. Field of the Invention

The present invention relates to an on-off valve that can replace related parts easily after releasing air pressure.

2. Description of the Prior Art

Referring to FIG. 1, a conventional on-off valve contains a body 10 including an air-inflow segment 11 and an air-outflow segment 12 disposed on two sides thereof respectively;

A valve structure 13 including a pad 131, an on-off shaft 132, a spring 133, and a nut 143, all of which are fixed in a hole 14 of the body 10 in order from the air-outflow segment 12, and the hole 14 includes inner threads 15, wherein one end of the spring 133 abuts against the on-off shaft 132 and includes a guiding peg 1321 extending out of the hole 14 to be pressed to retract backward so that the on-off shaft 132 disengages from the hole 14.

However, the hole 14 is drilled deeply from the air-outflow segment 12 to cause a high production cost and damage the structure strength of the conventional on-off valve

The present invention has arisen to mitigate and/or obviate the afore-described disadvantages.

### SUMMARY OF THE INVENTION

The primary object of the present invention is to provide an on-off valve of which the hole is drilled on the air-inflow segment so that related parts are replaced easily after releasing air pressure.

Another object of the present invention is to provide an on-off valve of which the hole has the small diameter to be worked at a lower cost and to keep a strong structure and an excellent anti-leak effect of the on-off valve.

An on-off valve in accordance with a preferred embodiment of the present invention contains:

a body including an air-inflow segment and an air-outflow segment disposed on two sides thereof respectively;

a valve structure including an inlet with a small diameter fixed on and communicating with the air-inflow segment and a hole with a large diameter formed on and not communicating with the air-inflow segment, wherein the hole includes inner threads proximate to an opening of the hole, the valve structure also includes a nut having outer threads, the outer threads of the nut screw with the inner threads of the body to position the valve structure, thus connecting the on-off valve together;

the valve structure also includes a spring, an on-off shaft, and the nut, the nut includes outer threads, a first bore, and a second bore to insert a guiding peg out of the body, and the guiding peg is arranged on the on-off shaft, one end of the spring abuts against a first free end of the on-off shaft, and a second free end of the spring is inserted into the hole of the body, the outer threads of the nut screw with the inner threads of the body to position the valve structure, thus connecting the on-off valve together.

### BRIEF DESCRIPTION OF THE DRAWINGS

FIG. 1 is a cross sectional view of a conventional on-off valve;

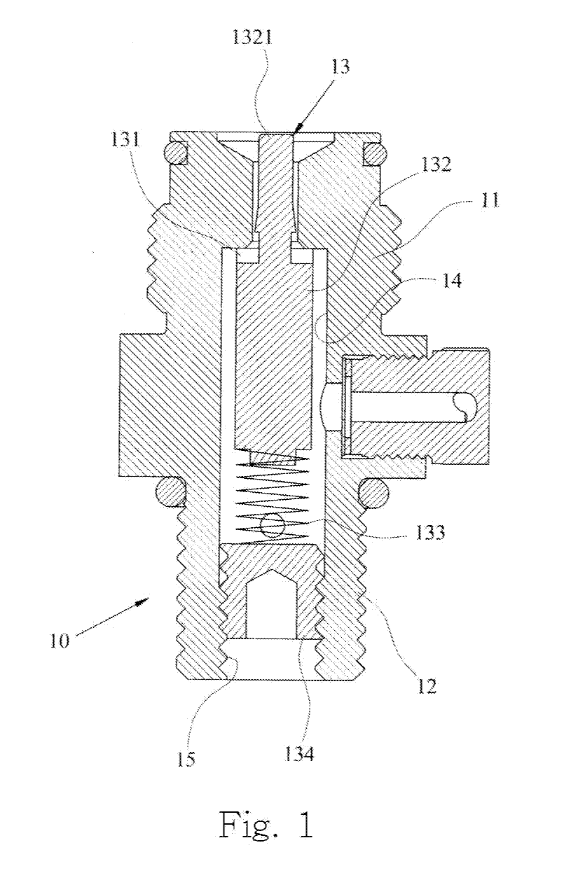

FIG. 2 is a perspective view showing the exploded components of an on-off valve in accordance with a preferred embodiment of the present invention;

FIG. 3 is a perspective view showing the assembly of the on-off valve in accordance with the preferred embodiment of the present invention;

FIG. 4 is a cross sectional view showing the assembly of the on-off valve in accordance with the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

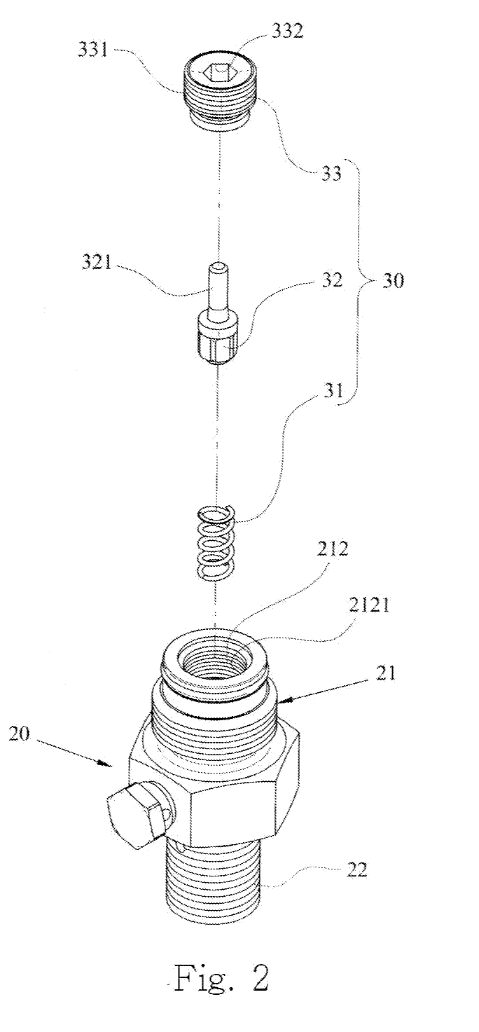

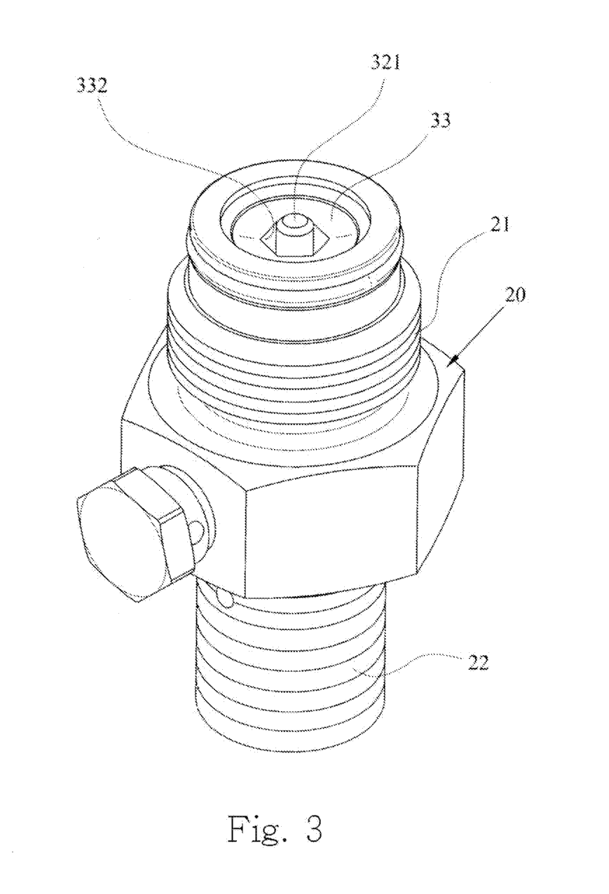

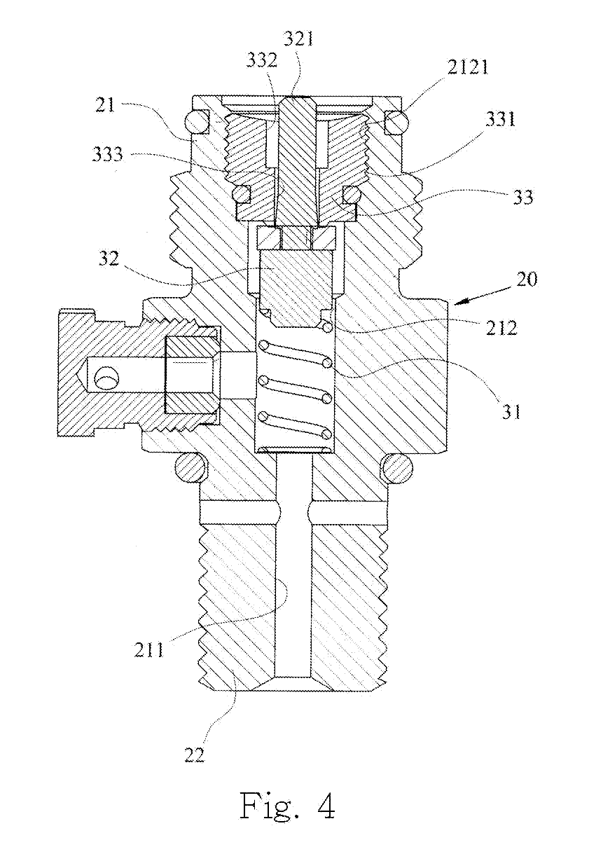

Referring to FIGS. 2-4, an on-off valve according to a preferred embodiment of the present invention comprises:

a body 20 including an air-inflow segment 21 and an air-outflow segment 22 disposed on two sides thereof respectively;

a valve structure 30 including an inlet 211 with a small diameter fixed on and communicating with the air-inflow segment 21 and a hole 212 with a large diameter formed on and not communicating with the air-inflow segment 21, wherein the hole 212 includes inner threads 2121 proximate to an opening of the hole 212, the valve structure 30 also includes a spring 31, an on-off shaft 32, and a nut 33, the nut 33 includes outer threads 331, a first bore 332, and a second bore 333 to insert a guiding peg 321 out of the body 20, and the guiding peg 321 is arranged on the on-off shaft 32, one end of the spring 31 abuts against a first free end of the on-off shaft 32, and a second free end of the spring 31 is inserted into the hole 212 of the body 20, the outer threads 331 of the nut 33 screw with the inner threads 2121 of the body 20 to position the valve structure 30, thus connecting the on-off valve together.

Thereby, the air-outflow segment 22 of the body 20 is provided to be connected with an high-pressure air bottle, and the air-inflow segment 21 is used to flow air into an air consuming equipment (such as a paintball gun), wherein the hole 212 is drilled on the air-inflow segment 21 so that related parts are replaced easily after releasing air pressure. Furthermore, the hole 212 has the small diameter to be worked at a lower cost and to keep a strong structure and an excellent anti-leak effect of the on-off valve.

While we have shown and described various embodiments in accordance with the present invention, it is clear to those skilled in the art that further embodiments may be made without departing from the scope of the present invention.

What is claimed is:

1. An on-off valve comprising:
a body including an air-inflow segment and an air-outflow segment disposed on two sides thereof respectively;
a valve structure including an inlet with a small diameter fixed on and communicating with the air-inflow segment and a hole with a large diameter formed on and not communicating with the air-inflow segment, wherein the hole includes inner threads proximate to an opening of the hole, the valve structure also includes a nut having outer threads, the outer threads of the nut screw with the inner threads of the body to position the valve structure, thus connecting the on-off valve together.

2. The on-off valve as claimed in claim 1, wherein the valve structure also includes a spring, an on-off shaft, and the nut, the nut includes outer threads, a first bore, and a second bore to insert a guiding peg out of the body, and the guiding peg is arranged on the on-off shaft, one end of the spring abuts against a first free end of the on-off shaft, and a second free end of the spring is inserted into the hole of the body, the outer threads of the nut screw with the inner threads of the body to position the valve structure, thus connecting the on-off valve together.
